(19) United States
(12) Patent Application Publication
(10) Pub. No.: US 2010/0104494 A1
(43) Pub. Date: Apr. 29, 2010

(54) Enhanced Optical Properties of Chemical Vapor Deposited Single Crystal Diamond by Low-Pressure/High-Temperature Annealing

(76) Inventors: Yu-fei MENG, Washington, DC (US); Chih-Shiue YAN, Washington, DC (US); Ho-kwang MAO, Washington, DC (US); Russell J. HEMLEY, Washington, DC (US)

Correspondence Address: MORGAN LEWIS & BOCKIUS LLP, 1111 PENNSYLVANIA AVENUE NW, WASHINGTON, DC, 20004, US

(21) Appl. No.: 12/605,422

(22) Filed: Oct. 26, 2009

Related U.S. Application Data
(60) Provisional application No. 61/108,283, filed on Oct. 24, 2008.

(51) Int. Cl. C01B 31/06; C09K 3/00

(52) U.S. Cl. 423/384; 423/446

(57) ABSTRACT

The method of improving the optical properties of single crystal CVD diamond which comprises annealing the crystals at a temperature of up to 2200° C. and a pressure below 300 torr.

This application claims priority to U.S. Provisional Application No. 61/108,283, filed on Oct. 24, 2008, hereby incorporated by reference.

### STATEMENT OF GOVERNMENT INTEREST

This invention was made with support from the National Science Foundation—EAR and—DMR, the U.S. Department of Energy—NNSA (CDAC) and the Balzan Foundation. The U.S. has certain rights to the invention.

### BACKGROUND OF THE INVENTION

1. Field of the Invention

The present invention relates to a method of improving the optical properties of diamond using a low pressure and high temperature technique. More particularly, the invention relates to a method of improving the optical properties of chemical vapor deposition (CVD) single-crystal diamond using a low pressure and high temperature technique.

2. Description of Related Art

Despite the large intrinsic band gap of diamond (5.5 eV), most natural diamond absorbs light in the ultraviolet, visible, and infrared spectral regions as a result of the presence of defects, impurities, and/or strain¹. High-pressure/high-temperature (HPHT) annealing has been shown to significantly alter the optical properties of diamond, specifically by lowering the UV-visible absorption, thereby increasing the potential use of the material in a variety of applications. Single-crystal diamond can be synthesized by chemical vapor deposition (CVD) techniques. Diamond produced in this fashion can exhibit a broad range of optical properties, from transparency to the intrinsic band gap to strong absorption throughout the visible spectrum. Single crystal chemical vapor deposited (SC-CVD) diamond can be produced at high growth rates (i.e., up to 150 μm per hour) by microwave plasma assisted techniques^{2,3}. Diamond produced at such high growth rates can exhibit a strong and broad UV-visible absorption, in part by the intentional addition of nitrogen (1-5% N₂/CH₄) to the synthesis process gas. Nevertheless, the nitrogen content can be low (<10 ppm), and the material is classified as type IIa diamond. This contrasts with brown natural type Ia diamond, which has a N content >100 ppm, and brown natural type IIa diamond, which is considered to have experienced extensive plastic deformation^{4, 5}. SC-CVD diamond can have much narrower x-ray rocking curves than natural brown diamond while also exhibiting extremely high fracture toughness⁶. It is found to have a remarkable low intensity of dislocations and is regarded as “high quality” brown diamond⁷. High-growth rate SC-CVD diamond can be HPHT-annealed to remove features in the optical spectrum⁶⁻¹⁰ and to tune its mechanical properties (i.e., hardness and toughness)⁶.

High-pressure/high-temperature annealing has become a commercial process for altering the optical properties of natural diamond^{11, 12}. This process requires temperatures in the range of 1800-2500° C.¹³, and pressures above 5 GPa are typically used to prevent diamond from graphitizing. However, the origins of the changes in optical properties and the annealing mechanism in both natural and CVD diamond remain unclear. The reduction in visible absorption for HPHT-annealed type IIa natural diamond with low nitrogen concentration has been attributed to the removal of strain associated with plastic deformation^{4, 12}. In HPHT-annealed type Ia natural diamond with high nitrogen concentration, it is believed that during annealing nitrogen aggregates are dissociated and vacancies released from dislocations. The vacancies are then trapped to form N-V-N centers^{11, 12}. High temperature treatment (>700° C.) at atmospheric pressure can decrease the visible absorption of brown natural diamond presumed to have experienced natural irradiation^{14, 15}. These processes are thought to produce damage in the form of isolated lattice vacancies and self-interstitials that can begin to migrate at temperatures around 600° C. and 425° C., respectively¹⁶⁻¹⁸. Thus, the response of diamond to high-temperature annealing varies depending on the origin of its UV-visible absorption features and the history of its growth and subsequent processing¹⁹.

“High quality” brown SC-CVD diamond exhibits fewer but characteristic defects as compared to brown natural diamond. This type of diamond contains a much lower density of dislocations than brown natural type IIa diamond that has presumably experienced plastic deformation^{4, 17}. Due to the nitrogen-containing growth environment with high concentrations of hydrogen, the as-grown brown CVD diamond incorporates nitrogen as substitutional nitrogen species Nₛ⁰ and Nₛ⁺⁸ and contains nitrogen-vacancy (NV⁻ and NV⁰), nitrogen-vacancy-hydrogen (NVH⁻)²⁰, vacancy-hydrogen²¹, and hydrogenated amorphous carbon (a-C:H)⁹ complexes, as revealed by EPR and PL measurements. Recent first-principles calculations suggest that the broad visible absorption of this diamond arises from vacancy disks in the {111} planes and that the optical activity of these disks can be passivated by hydrogen⁴. With the presence of hydrogen impurities and vacancies, color centers contributing to the visible absorption of CVD diamond may be less stable during annealing than the centers in brown natural diamond.

Diamond is an unstable form of carbon at atmospheric pressure and all temperatures²². High-temperature treatment of single crystal diamond at ambient pressure is usually performed in the temperature range 700° C. to 1600° C.¹¹; annealing at approximately 800° C. is often used as a treatment subsequent to the irradiation of diamond^{14, 23}. In order to prevent graphitization, for high temperatures (e.g., >1600° C.), high pressure annealing is usually used. In the case of SC-CVD diamond, as-grown crystals with less bulk defects than natural diamond have a lower probability of graphitization because graphite formation usually starts at discrete nucleation centers such as inclusions, boundaries and cracks²².

The high pressures used in the above-described HPHT annealing methods generally cause such methods to be costly. Accordingly, it is desirable to develop a low pressure method to anneal diamond.

### SUMMARY OF THE INVENTION

Broadly stated, the present invention is directed to methods of annealing diamond that substantially obviates one or more problems due to limitations of the related art.

Additional features and advantages of the invention will be set forth in the description which follows, and will be apparent from the description, or may be learned from the practice of the invention. The objectives and other advantages of the invention will be realized and attained by the structure particularly pointed out in the written description and claims.

The description reports effects of exposure of SC-CVD diamond produced at high growth rate to high temperatures and low (i.e., below atmospheric) pressure. The inventors have found significant changes in the optical properties of diamond without the occurrence of significant graphitization at temperatures up to 2200° C. A variety of spectroscopic methods are used to quantify the observed changes in optical properties and to provide insight into the origin of the phenomena.

According to the invention, single crystal diamond produced by chemical vapor deposition (CVD) at very high growth rates (up to 150 μm/h) has been successfully annealed without graphitization at temperatures up to 2200° C. and pressures below 300 torr. Crystals have been annealed in a hydrogen environment using microwave plasma techniques for periods of time ranging from a fraction of minute to a few hours. The low-pressure/high-temperature (LPHT) annealing enhances the optical properties of this high-growth rate CVD single crystal diamond. Significant decreases have been observed in ultraviolet to visible and infrared absorption as well as photoluminescence spectra. The dramatic decrease in optical absorption after the LPHT annealing arises from the changes in defect structure associated with hydrogen incorporation during CVD growth. There is a decrease in sharp line spectral features, indicating a reduction in nitrogen-vacancy-hydrogen (NVH⁻) defects. The measurements indicate an increase in relative concentration of nitrogen-vacancy (NV) centers in nitrogen-containing LPHT-annealed diamond as compared to as-grown CVD material. The large overall changes in optical properties as well as the specific types of alterations in defect structure induced by this facile LPHT processing of high-growth rate single-crystal CVD diamond will be useful in the creation of diamond for a variety of scientific and technological applications.

The methods of the invention can also relate to LPHT annealing of non-single-crystal diamond, including, but not limited to, polycrystalline CVD or HPHT diamond and natural diamond.

It is to be understood that both the foregoing general description and the following detailed description are exemplary and explanatory and are intended to provide further explanation of the invention as claimed.

### BRIEF DESCRIPTION OF THE DRAWINGS

The accompanying figures, which are included to provide a further understanding of the invention and are incorporated in and constitute a part of this specification, illustrate embodiments of the invention and together with the description serve to explain the principles of the invention.

FIG. 1 discloses diamond samples used for the LPHT annealing. Left images: Three segments of the same CVD diamond produced at a high growth rate. The middle piece is an as-grown segment; left and right are annealed segments (at 1900° C. for 2 minutes and at 1800° C. for 3 minutes respectively). Right images: SC-CVD diamond crystals. Top, as-grown (brown, 10×9×0.9 mm³); bottom, annealed at 1700-1800° C. for 15 minutes (brownish pink, 10×9×0.6 mm³).

FIG. 2 discloses the UV-visible absorption spectra of high-growth-rate SC-CVD diamond measured at 300 K, (a) before LPHT annealing, (b) after LPHT annealing at 1800° C. for 2 minutes. The inset shows annealed SC-CVD diamond produced at high growth rates

FIG. 3 discloses the Transparent LPHT-treated (up to 2000° C.) SC-CVD diamond plates produced at high growth rates.

FIG. 4 illustrates examples of photoluminescence spectra of three segments of the same CVD diamond measured at 77 K with 488 nm laser excitation. The intensities are normalized to the T_{2g} Raman peak of diamond at 522 nm. The spectra have been displaced vertically for clarity; Bottom: an as-grown segment; Middle: an LPHT annealed segment; Top: an HPHT annealed segment.

FIG. 5 illustrates examples of photoluminescence spectra of CVD diamond measured at 300 K with 488 nm laser excitation. The intensities are normalized to the T_{2g} Raman peak of diamond at 522 nm. The spectra have been displaced vertically for clarity; Left (a) before LPHT annealing, (b) after LPHT annealing at 1500° C. for 1 hour; Right: (a) before LPHT annealing, (b) after LPHT annealing at 1700° C. for 1 hour.

FIG. 6 discloses Infrared absorption spectra of CVD diamond produced at high growth rate: (a) as-grown crystal, (b) after LPHT annealing at 1600° C. for 10 minutes. The spectra are displaced vertically for clarity. The inset shows the CH stretching vibration region.

### DETAILED DESCRIPTION OF THE INVENTION

Reference will now be made in detail to the embodiments of the present invention.

Over forty SC-CVD diamond plates with nitrogen impurity below 10 ppm and thicknesses of 0.2 to 6 mm were subjected to LPHT processing at temperatures of 1400-2200° C. and at pressures below 300 torr. The samples were subsequently characterized by the following methods.

a. UV-Visible Absorption

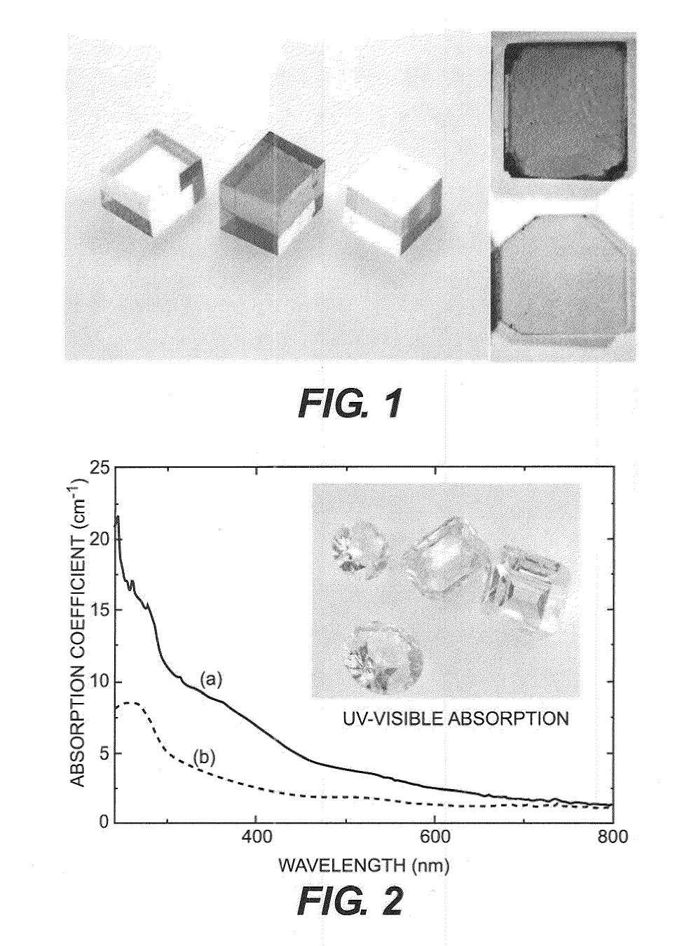

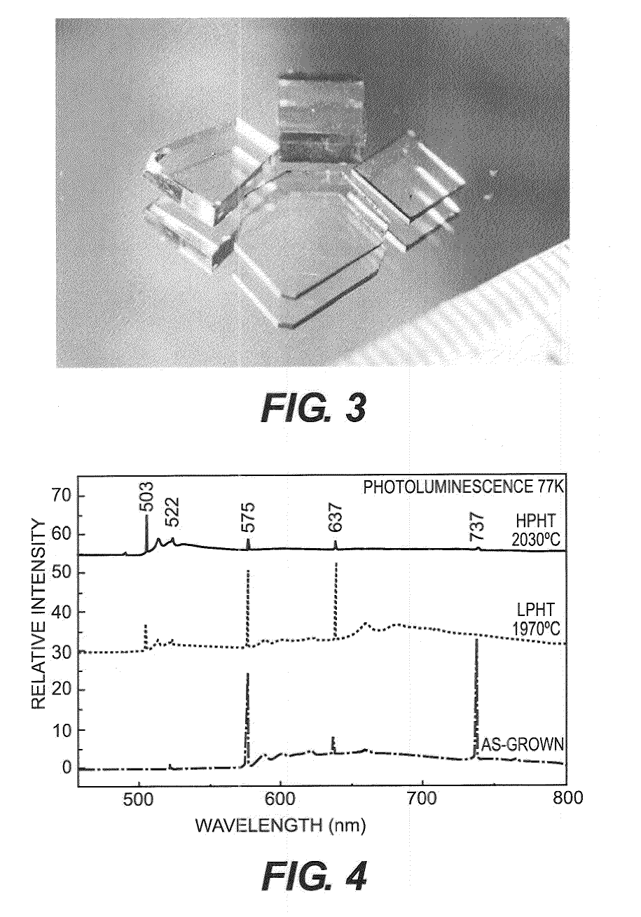

The LPHT treatment produced dramatic changes in optical properties of the high-growth rate CVD diamond (FIG. 1). The changes in optical properties of the bulk material are associated with a large decrease of UV-visible absorption spectrum (FIG. 2). Dark as-grown CVD diamond typically exhibits three broad bands in the UV-visible absorption spectrum, specifically at 270 nm, which arises from substitutional nitrogen⁸, 370 nm, and 550 nm⁸. The absorption coefficients were lowered by the annealing process by factors of 2 to 6. Similar changes in optical absorption have been reported following HPHT annealing^{8, 9}. In terms of gemological color grades calibrated and quantified by Adamas Gemological Laboratory SAS2000 spectrometer, the optical properties are improved in average by 3 grades (e.g., from J to G). No significant change in the UV-visible absorption of CVD diamond was observed after annealing at temperatures below 1600° C. FIG. 3 shows the much more transparent LPHT-treated SC-CVD diamond plates produced at a high growth rate.

b. Photoluminescence

The photoluminescence (PL) spectra were also measured. These spectra are characterized by PL systems with zero-phonon lines at 575 and 637 nm excited with a 488 nm argon-ion laser (FIG. 4). Using band assignment for previously reported PL spectra of diamond, these changes show that the original nitrogen-vacancy NV⁰ and NV⁻ centers at 575 nm and 637 nm, respectively, still exist after LPHT annealing and that the H3 center (N-V-N) at 503 nm, which did not exist before annealing, emerges after annealing. We also note that in most of samples the PL intensity at 737 nm associated with the silicon-vacancy center greatly decreased or disappeared after LPHT annealing. This change is probably associated with the disappearance of the red fluorescence.

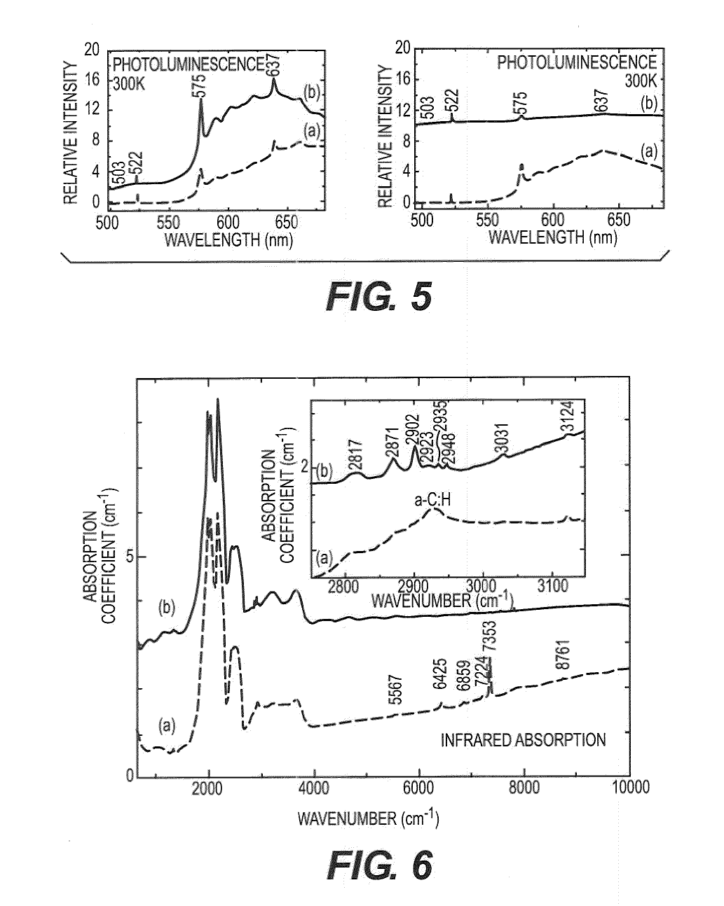

100261 These measurements show the NV centers react to the LPHT annealing in different ways depending on the annealing conditions (FIG. 5). At annealing temperatures below 1700° C. or short annealing times above 1700° C., the PL intensities of NV⁰ and NV⁻ centers increase by a factor of up to 5, which may explain the strong orange fluorescence induced by 488 nm excitation. Before annealing, the as-grown brown diamond shows a dark red fluorescence. The orange hue of the LPHT annealed CVD diamond is thought to come from this orange fluorescence. At temperatures over 1700° C. and longer annealing times, the PL from the NV⁰ and NV⁻ centers decreases. Unlike LPHT treatment, after HPHT annealing the NV centers either decrease or disappear and PL spectra are dominated by strong H3 centers (FIG. 4). The behavior of NV centers may have important implications for quantum computing applications²⁴.

c. Infrared Absorption

Infrared absorption spectroscopy is extremely useful for identifying impurities and defect species in diamond²⁵. IR absorption spectra of our samples reveal major changes in hydrogen-related vibrational and electronic transitions caused by the LPHT annealing. The inset of FIG. 6 shows the C—H stretching region at 2800 to 3200 cm⁻¹. The broad band at 2930 cm⁻¹ attributed to hydrogenated amorphous carbon (a-C:H)²⁶, is observed in the high-growth rate CVD diamond and its intensity correlates with that of the brown color of the diamond. After annealing, the IR spectrum in this region exhibits bands at 2810 cm⁻¹ (sp³-hybridized bonds on {111}^{27, 28}), 2870 cm⁻¹ (sp³-CH₃²⁷), 2900 cm⁻¹ (sp³-hybridized bonds on {100}, Ref.²⁶), 2925 cm⁻¹ (sp³-CH₂—), 2937 cm⁻¹, 2948 cm⁻¹, 3032 cm⁻¹, and 3053 cm⁻¹ (sp²-hybridized bonds^{27, 29}). The results indicate that the dangling bonds of the a-C:H on {100} in the as-grown brown CVD diamond are transformed by LPHT annealing to a locally denser structure (e.g., Ref 6) and a lower overall UV-visible absorption. Possible mechanisms for the production of the enhanced optical properties have been described in Ref. 4 based on the changes in C-H stretching vibrations of the HPHT annealed CVD diamond^{6, 8}. In the near IR region (FIG. 6), the main absorption bands at 7357 cm⁻¹, 7220 cm⁻¹, 6856 and 6429 cm⁻¹, and weaker peaks at 8761 and 5567 cm⁻¹ greatly decreased or disappeared after LPHT annealing. Moreover, the absorption continuum increasing from 5000 to 10000 cm⁻¹ also decreased.

The LPHT annealing effects described above are broadly similar to those of HPHT annealing⁸ but with the following differences: The LPHT annealed and as-grown CVD diamond both exhibit a peak at 3124 cm⁻¹ (attributed to H involving one C³⁰) and bands at 7357 cm⁻¹, 7220 cm⁻¹, 6856 cm⁻¹, and 6429 cm⁻¹ which are not observed in the HPHT-treated CVD diamond. The LPHT-treated CVD diamond does not exhibit the 3107 cm⁻¹ absorption feature (sp²-CH═CH—^{31, 32}, related to gray color and existing in the HPHT annealed samples⁸) as well as the bands at 2972 cm⁻¹ (sp²-CH₂—²⁷) and 2991 cm⁻¹. Finally, the high-pressure induced sp³ C—H bond shifted by 3-15 cm⁻¹ higher wave numbers at 2820 cm⁻¹, 2873 cm⁻¹ and 2905 cm⁻¹, present in the HPHT-annealed samples is absent in the LPHT-treated crystals.

Characterizations of SC-CVD diamond produced by high growth rate techniques before and after the LPHT processing provide information on the annealing mechanism of these materials. UV-visible, PL and IR measurements on SC-CVD diamond compared with data on diamonds subjected to HPHT annealing reveal insights into the origin of the diverse spectroscopic features reported for diamond in general. As the annealing temperature increases, the PL and IR spectra indicate the existence of three temperature regimes associated with changes in the properties of these diamonds. When the temperature reaches 700° C., vacancies become mobile¹⁶⁻¹⁸. Some of these vacancies are subsequently trapped by substitutional Nₛ centers and cause an increase in the number of NV centers. This is the reason why PL intensities associated with NV⁰ and NV⁻ centers increase after annealing at lower temperatures or for shorter times.

The broad visible absorption giving rise to brown color remains unchanged until the diamond is annealed to above 1400° C., at which the diamond begins to become more transparent. The intensities of the 270 nm and 370 nm absorption bands decrease, while the intensity of the absorption band near 550 nm increases or remains unchanged. While not bound by theory, the inventors suggest that hydrogen migrates at this temperature. Hydrogen is usually the most abundant impurity in the diamond grown under the conditions described herein. The formation of brown diamond with nitrogen present in the gas could be due to the enhancement of growth rate by nitrogen; diamond produced at this high growth rate has more extended defects (i.e., under-bonded carbon or vacancy clusters). Nitrogen could decorate these defects, and hydrogen is incorporated with those defects as unstable centers: a-C:H (and other hydrogen-related infrared absorption bands) and NVH⁻²¹. Both HPHT and LPHT annealing mobilize the incorporated hydrogen. There is evidence that annealing of polycrystalline CVD diamond at about 1400° C.³³ causes hydrogen located on internal grain boundaries or in the inter-granular material to become mobile. IR absorption spectra after annealing reveal that the concentration of a-C:H decreases and hydrogen forms stable C-H bonds on {100} and {111}. First principles calculations suggest that the largely featureless absorption spectra of brown diamond is attributed to vacancy disks lying on {111} planes and that hydrogen can passivate the optical activity of the disks resulting in reduced absorption⁴.

The 370 nm absorption feature may be associated with hydrogen-related defects³⁵. CVD diamond annealed in this temperature regime usually attains a brownish pink color, indicating that the pink hue of the annealed CVD diamond is associated with the 550 nm band, and very likely originates from the NV centers. While not bound by theory, the inventors propose that the 550 nm absorption band corresponds to emission associated with NV centers at 575 nm and 637 nm. However, the 550 nm absorption feature is very broad and does not coincide with the electron-phonon bands at 575 nm or 638 nm and cannot be directly correlated with NV centers. It is possible that these spectral features are associated with NV centers, and the 550 nm absorption band corresponds to the broad fluorescence superimposed by emission associated with NV centers, which may due to the vacancy discs or clusters decorated by a low concentration of nitrogen. Detailed study, in particular at low temperatures, is needed to provide detailed band assignments and further information about the origin of these optical features.

The most significant changes are observed at temperatures higher than 1700° C., at which some nitrogen-related defects become mobile. It is possible that vacancies are more easily trapped by hydrogen than by nitrogen at temperatures at which hydrogen atoms are mobile. At the same time, at higher temperatures the stable NV centers are annealed out since N also tends to form H3 aggregates. Another change that can happen at elevated temperatures is the breaking of the C—H bonds, which can also cause loss of hydrogen. Such an effect has been observed during annealing of polycrystalline CVD diamond at 1600° C.³³. In our experiments, the hydrogen content²⁷ calculated from the integrated intensities of the C—H band decreased from 4 ppm to 1.5 ppm (FIG. 6). We observed a decrease in intensity of the C—H stretching band after annealing at even higher temperatures (1800-2200 ° C.).

The results of the LPHT annealing process indicate that the intensity of the 370 nm absorption band correlates with the absorption continuum increasing toward shorter wavelengths, while the persistence of the 550 nm band shows a correspondence with the residual absorption features. There are three main factors that are related to the broad visible absorption of CVD diamond: nitrogen, vacancies, and hydrogen. The intensity of the continuum absorption in UV-visible range for the as-grown CVD diamond depends on the concentration of nitrogen in the gas used for the CVD process². The broad absorption increases with increasing PL intensity of the NV⁰ (575 nm) and NV⁻ (637 nm) centers. The transparent as-grown CVD diamond has either no or very low content of NV centers. When the optical absorption of diamond is annealed out, the number of NV centers is reduced. PL spectra in type IIa natural brown diamond reveal the presence of NV centers while no NV luminescence is observed in type IIa natural diamond that is nearly transparent in the UV-visible range³⁴. The HPHT-treated type IIa natural brown diamond exhibits a small number of NV centers, but the darker the crystal absorption, the stronger the NV⁻ fluorescence band³⁴. However, while LPHT annealing decreases the broad absorption, instead of decreasing the number of the NV centers, the intensity of the corresponding band increases, which shows that the NV centers are not the only cause of the absorption.

CVD diamond grown at high rates can be very different from natural diamond. The major characteristic impurity in our standard high-growth rate CVD is hydrogen and that impurity is associated with under-bonded carbon (e.g., π-bonds in extended defects) or vacancy clusters, which may be decorated by nitrogen. The a-C:H peak in brown CVD diamond is replaced after annealing by various well-resolved C—H stretching bands, while the intensities of hydrogen-induced electronic absorption bands decrease. The 3124 cm⁻¹ and the a-C:H vibrational bands, as well as electronic transitions associated with hydrogen-related centers in the near-IR region, are absent in the transparent CVD diamond grown without the addition of nitrogen³. This observation suggests that hydrogen-related defects correlate with nitrogen impurities. Nitrogen doping promotes {100} faceted growth. Orange to orange red luminescence as well as striations is typically observed for N-doped CVD diamond. These striations are a result of different uptake of impurity-related defects on the risers and terraces of surface growth steps⁹.

The a-C:H peak at 2930 cm⁻¹ occurs in the region that corresponds to absorption of C—H groups on {100}. In hydrogen-rich natural diamond, hydrogen is incorporated mostly in cuboid sectors³⁵. The 370 nm band is present in brown cuboid sectors while absent in gray octahedral sectors in the same diamond³⁵. Hydrogen may be incorporated into NV complexes on {100} in CVD diamond during growth. NVH⁻ is a common defect in nitrogen doped SC-CVD diamond and can be present in higher concentrations than the NV centers²¹. It has been proposed that hydrogen atoms are bonded to the nitrogen, and the unpaired electrons located in the dangling bonds of the three equivalent nearest-neighbor carbon atoms, with very little localization on the nitrogen²⁰. EPR spectra show that the NVH⁻ centers exist in our as-grown nitrogen doped CVD diamond and that they are removed by both the LPHT and HPHT treatment^{36, 8}. Concentrations of paramagnetic defects follow the sequence Nₛ⁰>NVH⁻>NV⁻ (Ref. ^{36, 8}). The intensities of the three UV-visible absorption bands follow the order 270 nm (Nₛ)>370 nm (unknown)>550 nm (possibly NV related). The NVH⁻ centers may also be associated with the 3124 cm⁻¹ feature and the near-IR hydrogen-induced electronic absorption. The 370 nm emission was observed in brown CVD diamond after irradiation and its intensity increased as the nitrogen intensity increased in local areas⁷.

The susceptibility of the electron-phonon vacancy related color centers to LPHT processing makes it possible to reduce broad visible absorption of CVD diamond produced at high growth rates. Movement of hydrogen atoms from the unstable hydrogen-incorporated centers (e.g., NVH⁻) to more stable C—H bonds can explain the dramatic enhancement in optical transparency of this diamond. We also note that the SC-CVD diamond can endure longer annealing times than polycrystalline CVD diamond without graphitization.

Processing SC-CVD diamond at low pressures and high temperatures (LPHT) has been shown to be effective in enhancing the optical properties of these crystals, and this treatment provides important insight into the defects and impurities associated with diamond. In contrast to HPHT annealing, this LPHT method is applicable in CVD reactors as a subsequent treatment after growth and not constrained by the size of the crystals. Spectroscopic characterization of LPHT annealed crystals has advanced the understanding of the mechanism of annealing. The 370 nm absorption band causing the increasing absorption continuum towards shorter wavelengths in UV-visible range of as-grown SC-CVD diamond appears to originate from the presence of hydrogen incorporated extended defects (under-bonded carbon or vacancy clusters), which may be decorated with nitrogen forming defect centers (e.g. NVH⁻). The optical enhancement may be attributed to the changes in defect structure associated with hydrogen incorporation during CVD growth. There is a decrease in sharp line spectral features indicating a reduction in NVH⁻ defects. We suggest that the 550 nm absorption causing residual absorption of the annealed CVD diamond can be associated with the increased concentration of the NV centers as compared to as-grown CVD diamond. As the spin associated with the NV complex may have a practical use, and the number of NV⁻ complexes could be controlled by the LPHT annealing process, the LPHT-annealed SC-CVD diamond could be a promising material for applications such as quantum computing, which require detailed information on the concentration and distribution of these complexes.

SC-CVD diamond samples were produced by the MPCVD method described elsewhere^{2,3}. Typically the diamond samples were grown under the following conditions: N₂/CH₄=0.2-5.0%, CH₄/H₂=12-20%, total pressures of 1.20-220 torr, and temperatures of 900-1500° C. For the purpose of annealing, a 6 kW, 2.45 GHz microwave plasma CVD system with a redesigned cavity and molybdenum substrate stage was used to generate stable and energetic hydrogen plasmas². SC-CVD diamond plates were heated in the CVD chamber to temperatures in the range 1400° C. to 2200° C., at pressures between 150-300 torr. Typically, samples were heated stepwise to the maximum annealing temperature, kept at the maximum temperature for a chosen time, and ramped down to room temperature. The processing conditions are summarized in Table 1. Temperatures were measured by an infrared two-color pyrometer. It should be noted that all diamond used in the experiments consisted of high quality single crystal material in order to prevent significant graphitization and cracking at temperatures over 1600° C. at low pressures outside the diamond stability range, and energetic hydrogen plasma etch⁶.

TABLE 1
LPHT annealing conditions of brown SC-CVD diamond

| Temperature (° C.) | Pressure (torr) | Time (min) |
|---|---|---|
| 2100-2200 | 220-300 | 0.1-0.5 |
| 1700-2000 | 200-220 | 1-60 |
| 1400-1600 | 150-200 | 10-720 |

Samples were characterized before and after LPHT processing by micro-photoluminescence (PL), and micro-UV-visible and synchrotron IR absorption spectroscopy. Photoluminescence spectra were measured at room temperature using a custom-built micro Raman/PL system. PL spectra were typically excited by the 488 nm of an argon-ion laser. The laser power was about 50 mW and the focal spot diameter was about 5 μm. The UV-visible absorption spectra were measured at room temperature with a custom-built micro UV-visible absorption setup based on an Ocean Optics spectrometer. The spot diameter was about 20 μm. Synchrotron IR absorption spectra were obtained at the U2A beamline of the VUV ring of the National Synchrotron Light Source (NSLS), Brookhaven National Laboratory. The spectra were measured in the range 400-10000 cm⁻¹.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

### REFERENCES

1. Fritsch, E., The Nature of Diamonds (ed. G. E. Harlow) (Cambridge University Press, Cambridge, 1998).
2. Yan, C. S., Y. K. Vohra, H. K. Mao, and R. J. Hemley, Very high growth rate chemical vapor deposition of single-crystal diamond, Proc. Nat. Acad. Sci., 99, 12523-12525 (2002).
3. Ho, S. S., C. S. Yan, Z. Liu, H. K. Mao, and R. J. Hemley, Prospects for large single crystal CVD diamonds, Industrial Diamond Review, 66, 28-32 (2006).
4. Hounsome, L. S., R. Jones, P. M. Martineau, D. Fischer, M. J. Shaw, P. R. Briddon, and S. Öberg, Origin of brown coloration in diamond, Phys. Rev. B, 73, 125203 (2006).
5. Mao, H. K. and Hemley R. J., Optical transitions in diamond at ultrahigh pressure, Nature, 351, 721-724 (1991).
6. Yan, C. S., H. K. Mao, W. Li, J. Qian, Y. Zhao, and R. J. Hemley, Ultrahard diamond single crystals from chemical vapor deposition, Phys. Stat. Sol. (a), 201, R25-R27 (2004).
7. Mora, A. E., J. W. Steeds, J. E. Butler, C. S. Yan, H. K. Mao, and R. J. Hemley, Direct evidence of interaction between dislocations and point defects in diamond, Phys. Stat. Sol. (a), 202, R69-R71 (2005).
8. Charles, S. J., J. E. Butler, B. N. Feygelson, M. Newton, D. L. Carroll, J. W. Steeds, H. Darwsh, C. S. Yan, H. K. Mao, and R. J. Hemley, Characterization of nitrogen doped chemical vapor deposited single crystal diamond before and after high pressure, high temperature annealing, Phys. Stat. Sol., 242, 2473-2485 (2004).
9. Martineau, P. M., S. C. Lawson, A. J. Taylor, S. J. Quinn, D. J. F. Evans, and M. J. Crowder, Identification of synthetic diamond grown using chemical vapor deposition (CVD), Gems. Gemol., 40, 2-25 (2004).
10. Wang, W. Y., T. Moses, R. C. Linares, J. E. Shigley, M. Hall, and J. E. Butler, Gem-quality synthetic diamonds grown by a chemical vapor deposition (CVD) method, Gems. Gemol., 39, 268-283 (2003).
11. Collins, A. T., A. Connor, C. H. Ly, A. Shareef, and P. M. Spear, High-temperature annealing of optical centers in type-I diamond, J. Appl. Phys., 97, 083517 (2005).
12. Collins, A. T., H. Kanda, and H. Kitawaki, Colour changes produced in natural brown diamonds by high-pressure, high-temperature treatment, Diamond Relat. Mater., 9, 113-122 (2000).
13. Fisher, D. and R. A. Spits, Spectroscopic evidence of GE POL HPHT-treated natural type IIa diamonds, Gems. Gemol., 36, 42 (2000).
14. Peng, M. S., Gemstone Enhancement and Modern Measurement Technique (Science Press, Beijing, 1995).
15. Peng, M. S., X. Q. Li, and X. M. Fu, Diamond enhancement technique, Human Geology, Supp., 17-21 (1992).
16. Davies, G., S. C. Lawson, A. T. Collins, A. Mainwood, and S. J. Sharp, Vacancy-related centers in diamond, Phys. Rev. B, 46, 13157 (1992).
17. Goss, J. P., M. J. Rayson, P. R. Briddon, and J. M. Baker, Metastable Frenkel pairs and the W11-W14 electron paramagnetic resonance centers in diamond, Phys. Rev. B, 76, 045203 (2007).
18. Hunt, D. C., D. J. Twitchen, M. E. Newton, J. M. Baker, T. R. Anthony, W. F. Banhoizer, and S. S. Vagarali, Identification of the neutral carbon <100>-split intertitial in diamond, Phys. Rev. B, 61, 3863 (2000).
19. Meng, Y. F., Studies on defects and coloration mechanism of brown diamond, (Sun Yat-sen University, China, 2006).
20. Glover, C., M. E. Newton, P. M. Martineau, D. J. Twitchen, and J. M. Baker, Hydrogen incorporation in diamond: The nitrogen-vacancy-hydrogen complex, Phys. Rev. Lett., 90, 185507 (2003).
21. Glover, C., M. E. Newton, P. M. Martineau, S. Quinn, and D. J. Twitchen, Hydrogen incorporation in diamond: The vacancy-hydrogen complex, Phys. Rev. Lett., 92, 135502 (2004).
22. Field, J. E., The Properties of Diamond (Academic Press, London, 1979).
23. Collins, A. T., The detection of colour-enhanced and synthetic gem diamonds by optical spectroscopy, Diamond Relat. Mater., 12, 1976-1983 (2003).
24. GurudevDutt, M. V., L. Childress, L. Jiang, E. Togan, J. Maze, F. Jelezko, A. S. Zibrov, P. R. Hemmer, and M. D. Lukin, Quantum register based on individual electronic and nuclear spin qubits in diamond Science, 316, 1312-1316 (2007).
25. A. M. Zaitsev, Optical Properties of Diamonds (Springer-Verlag, Berlin, 2001).
26. Prelas, M. A., G. Popovici, and L. K. Bigelow, Handbook of Industrial Diamonds and Diamond Films (Dekker, New York, 1998).
27. Dischler, B., C. Wild, W. Müller-Sebert, and P. Koidl, Hydrogen in polycrystalline diamond—An infrared analysis Physica B, 185, 217-221 (1993).
28. Titus, E., D. S. Misra, A. K. Sikder, P. K. Tyagi, M. K. Singh, A. Misra, N. Ali, G. Cabral, V. F. Neto, and J. Gracio, Quantitative analysis of hydrogen in chemical vapor deposited diamond films, Diamond Relat. Mater., 14, 476-481 (2005).
29. John, P., D. K. Milne, I. C. Drummond, M. G. Jubber, J. I. B. Wilson, and J. Savage, IR attenuated total reflectance studies of d.c. biased growth of diamond films, Diamond Relat. Mater., 3, 486-491 (1994).
30. Fuchs, F., C. Wild, K. Schwarz, W. Müller-Sebert, and P. Koidl, Hydrogen induced vibrational and electronic transitions in chemical vapor deposited diamond, identified by isotopic substitution, Appl. Phys. Lett., 66, 177-179 (1995).
31. Field, J. E., The Properties of Natural and Synthetic Diamond (Academy Press, London, 1992).
32. Woods, G. S. and A. T. Collins, Infrared absorption spectra of hydrogen complexes in type &#8544; diamond, J. Phys. Chem. Solids, 44, 471-475 (1983).
33. Talbot-Ponsonby, D. F., M. E. Newton, J. M. Baker, G. A. Scarsbrook, R. S. Sussmann, and A. J. Whitehead, EPR and optical studies on polycrystalline diamond films grown by chemical vapor deposition and annealed between 1100 and 1900 K, Phys. Rev. B, 57, 2302-2309 (1998).
34. Chalain, J. P., E. Fritsch, and H. A. Hänni, Identification of GE POL diamonds: a second step, J Gemm, 27, 73-78 (2000).
35. Rondeau, B., E. Fritsch, M. Guiraud, J. P. Chalain, and F. Notari, Three historical ‘asteriated’ hydrogen-rich diamonds: growth history and sector-dependent impurity incorporation, Diamond Relat. Mater., 13, 1658-1673 (2004).

What is claimed is:

1. A method of improving the optical properties of diamond, said method comprising annealing the diamond at a temperature of up to 2200° C. and a pressure below 300 torr.

2. The method of claim 1 wherein the diamond is single crystal CVD diamond.

3. The method of claim 2 wherein the diamond is nitrogen-doped brown single crystal CVD diamond.

4. The method of claim 2 wherein the annealing occurs without graphitization.

5. The method of claim 1 wherein the annealing is carried out in a hydrogen environment using microwave plasma technique for a period of time ranging from a fraction of a minute (e.g. 30 seconds) to a few hours (e.g. 3-6 hours).

6. The method of claim 5 wherein the annealed diamond contains an increased number of NV centers as compared to the as-grown CVD diamond.
